(19) United States
(12) Patent Application Publication
(10) Pub. No.: US 2017/0098282 A1
(43) Pub. Date: Apr. 6, 2017

(54) SOCIAL MEDIA INTEGRATION IN OMNI-CHANNEL CUSTOMER ISSUE RESOLUTION

(71) Applicant: Avaya Inc., Santa Clara, CA (US)

(72) Inventors: Reinhard Klemm, Basking Ridge, NJ (US); David Skiba, Golden, CO (US)

(21) Appl. No.: 14/873,507

(22) Filed: Oct. 2, 2015

(51) Int. Cl. G06Q 50/00; G06Q 30/00

(52) U.S. Cl. CPC G06Q 50/01; G06Q 30/016

(57) ABSTRACT

Customers may use a number of channels to communicate with a business or other organization. If a customer initially posts an issue on social media and, before seeing a response, initiates a communication via a different channel (e.g., telephone call, email, etc.) to address the same issue, duplicative efforts may be reduced or eliminated. The customer is identified as being associated with the social media post and background information may be extracted from the social media post. If the issue is addressed on the social media site, the customer is notified, even if they are presently engaged in the communication via the different channel. If the customer is satisfied with the response, they may discontinue the communication via the different channel. If the customer is not satisfied, an agent may be assigned based, at least in part, on information gained from the social media website.

### FIELD OF THE DISCLOSURE

The present disclosure is generally directed toward matching activity on one electronic network to activity on a second electronic network.

### BACKGROUND

Electronic communication networks, such as social media websites, allow connectivity of individuals and organizations. In addition to the social aspect, social media is often used for other purposes, such as a customer service channel enabling customers to post issues with products and services associated with a business. Many businesses either do not have staff allocated to respond to social media posts or, those that do, may not be able to respond to social media posts in a timely manner. Customers requiring a more prompt response may escalate an issue by seeking resolution from a secondary customer service channel, such as a toll-free call to the business, for example. The customer service agent, utilizing a more traditional telephone-based channel, is disconnected from the customer's prior activity on the social media site.

As a result, the customer service agent requires the customer to restate the issue, previous resolution attempts, or other relevant information, even if such information was already provided by the customer on the social media channel.

### SUMMARY

It is with respect to the above issues and other problems that the embodiments presented herein were contemplated. Utilizing social media to provide customer service has became increasingly popular. However, customers may start a work item (e.g., inquiry, service request, etc.) in a social media channel and, before a response can be provided on the social media channel, or at least before the customer realizes a response has been provided, the customers may duplicate the work item on a more traditional non-social media channel, such as by making a telephone call to the business. With respect to certain embodiments disclosed herein, a response may be provided to the customer while they are engaged on a non-social media channel, such as a telephone. The customer may then be provided with the opportunity to review the social media response and, if the response is sufficient, discontinue the non-social media channel. If no response, or a non-sufficient response, has been provided on the social media channel, the customer may continue the non-social media channel, such as to discuss the work item with an agent. Once resolved, the agent's response may be automatically provided or the agent may be prompted to provide the response to the social media channel. As a benefit, additional or potential customers who see the social media thread will discover the response and the goodwill of the business may be maintained or improved as compared to no response or a slow response. While a voice telephone may be a more common non-social media channel selected by a customer, email, text messages, video chat, in-person (e.g., kiosk, service desk), and other non-social media channels are contemplated by the embodiments disclosed herein.

In another embodiment, the non-social media channel may be a social media channel that is different from the social media channel. For example, a customer may initiate an exchange with an organization on a first social media website (e.g., Facebook) and, if no timely response is apparent to the customer, the customer may reinitiate the exchange on a second social media website (e.g., Twitter) in which the customer interacts with the organization.

In another embodiment, relevant portions of a customer's work item on a social media channel are provided to a non-social media customer service channel during a customer-driven escalation from a social media post to the non-social media channel. The visibility of the customer's work item on a social media context in a non-social media channel reduces the need for the customer to repeatedly state their issue, which reduces the burden on computational, network, and human resources and may support a “familial” conversation style by which the agent can utilize the information provided on the social media channel to make the customer feel like an acquaintance rather than just another caller. Context may be provided back from the non-social media channel to the social media channel by automatically posting a response to the customer's social media post(s) once the agent/customer interaction has concluded. As a benefit, other users of the social media channel are able to see that the business has handled this customer's issue and may also see the resolution. As a further benefit, other users having the same issue may see the response on the social media website and apply it to their own situation, thereby further reducing computational, bandwidth, and/or human resources that would otherwise be required to address the same or similar issues. As still another benefit, the duplication of efforts and resources deployed to address the issue on the social media channel and the non-social media channel may be reduced or eliminated.

In another embodiment, a continuous (uninterrupted or intermittent) collection of data from one or more social media channels may be performed for a given domain, such as a particular business or organization. For example, a customer escalates a social media post with a call to a business's contact center, identifies themselves through an interactive voice response (IVR) prompts, and selects an item from an IVR menu. Analysis of postings on one or more social media channels determines if the caller is associated with a post on social media. If posting activity is found, the non-relevant posts may be filtered out, such as posts based on the following: (1) time (e.g., posts older than a configurable time unit may be discarded), (2) the customer's IVR selection (e.g., indicating a different issue, providing supplemental information for a prior issue, or an explicit request to speak with an agent), and/or (3) content (e.g., posts that do not contain customer requests for business assistance may be discarded).

Posts, in the set P of remaining social media posts, if any, have a greater likelihood of relevance to the customer's current call. The customer's social media context may also be retrieved, such as to access the customer's social network user profile and/or previous social media activities.

If all posts in P have been answered by the business (i.e., by representatives of the business's social media operations, typically marketing resources), a text-to-speech notification may be injected into the open voice connection to the customer to inform the customer that the business has recently responded to posts from this customer. The notification may end with a prompt that asks whether the customer wants to disconnect or wait for the next available agent. The customer is given a certain time interval for responding to this prompt. The customer may use this time to access and review recent responses to their social media posts and decide whether the response(s) solve the customer's issue.

If P contains unanswered posts, or if the customer decides to hold for the next available agent, the customer is routed to an agent. The particular agent may be selected in accord with content analysis of the posts in P and/or attributes of the customer's social media context (e.g., language, background, etc.). An agent assigned to the customer may be provided with the customer's post and/or social media context. The agent may then review the posts and social media context and may further access potential solution(s) to the customer's issue determined from the posts. The agent is connected to the customer via a voice call or other non-social media channel. The agent may then confirm with the customer that the customer is indeed calling about the issues raised in the customer's social media post(s). Beyond knowing the customer's current issue, the agent may also know the customer's expanded social media context (e.g., profile entries, past postings, associations, interests, demographic attributes, etc.) and can use this knowledge to connect with the customer on an informal level during the conversation.

Once the customer's issue has been resolved by the agent, a response to the customer's social media post(s) may be automatically generated. The response may document the handling of the issue raised in the post(s), confirm the issue has been resolved, or provide other information as may be relevant to a particular customer's post(s) or issue. In one embodiment, the automatically generated response may be posted without any further human intervention. In another embodiment, the automatically generated response may be sent to the agent for approval and/or editing prior to posting on the social media website. In yet another embodiment, the agent may be prompted to provide the content of the response, such as when an automatically generated response is not available.

As a benefit to providing the response, other customers in the social media community may become aware of the business's handling of the customer's issue and, if they are experiencing the same or similar issue, may apply the resolution to their own circumstance.

In one embodiment, a system is disclosed comprising: a network interface that accesses content from a social media website and receives a communication via a communications network different from the social media website; and

a processor that, upon determining that the communication from the communications network is associated with content from the social media website, causes the communications network to present a notification to a contact center person associated therewith, the notification comprising indicia of the associated content from the social media website.

In another embodiment, a means is disclosed for determining association between a customer communicating on a communications network and content on a social media website, comprising: accessing means configured to access content from a social media website and receive a communication via the communications network different from the social media website; and determining means configured to determine that the communication from the communications network is associated with content from the social media website and cause a presentation means to present a notification to at least one of a contact center person engaged in the communication, the notification comprising indicia of the associated content from the social media website.

In another embodiment, a method is disclosed comprising: accessing content from a social media website; receiving a communication via a communications network different from the social media website; and upon determining that the communication from the communications network is associated with content from the social media website, presenting a notification to at least one of a contact center person engaged in the communication, the notification comprising indicia of the associated content from the social media website.

The term “contact center person” refers to an individual, such as a human agent, of a contact center providing services to a customer and/or to the customer interacting with a resource of the contact center.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium,” as used herein, refers to any tangible storage that participates in providing instructions to a processor for execution. Such a medium may take many forms, including, but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid-state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module,” as used herein, refers to any known or later-developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a second system in accordance with embodiments of the present disclosure;

FIG. 3 depicts a third system in accordance with embodiments of the present disclosure;

FIG. 4 depicts a data structure in accordance with embodiments of the present disclosure;

FIG. 5 depicts a first process in accordance with embodiments of the present disclosure; and

FIG. 6 depicts a second process in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

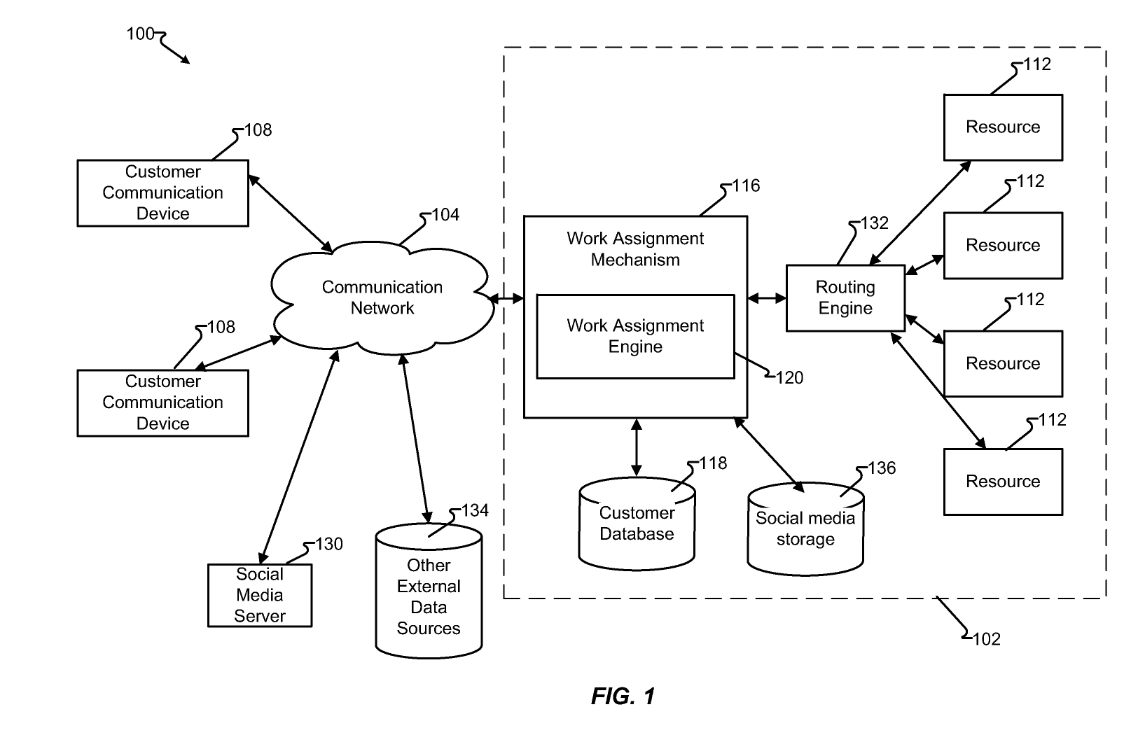

With reference now to FIG. 1, communication system 100 is discussed in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering contact center 102 in which a plurality of resources 112 are distributed to handle incoming work items (in the form of contacts) from customer communication devices 108.

Contact center 102 is variously embodied to receive and/or send messages that are or are associated with work items and the processing and management (e.g., scheduling, assigning, routing, generating, accounting, receiving, monitoring, reviewing, etc.) of the work items by one or more resources 112. The work items are generally generated and/or received requests for a processing resource 112 embodied as, or a component of, an electronic and/or electromagnetically conveyed message. Contact center 102 may include more or fewer components than illustrated and/or provide more or fewer services than illustrated. The border indicating contact center 102 may be a physical boundary (e.g., a building, campus, etc.), legal boundary (e.g., company, enterprise, etc.), and/or logical boundary (e.g., resources 112 utilized to provide services to customers for a customer of contact center 102).

Furthermore, the border illustrating contact center 102 may be as-illustrated or, in other embodiments, include alterations and/or more and/or fewer components than illustrated. For example, in other embodiments, one or more of resources 112, customer database 118, and/or other component may connect to routing engine 132 via communication network 104, such as when such components connect via a public network (e.g., Internet). In another embodiment, communication network 104 may be a private utilization of, at least in part, a public network (e.g., VPN); a private network located, at least partially, within contact center 102; or a mixture of private and public networks that may be utilized to provide electronic communication of components described herein. Additionally, it should be appreciated that components illustrated as external, such as social media server 130 and/or other external data sources 134 may be within contact center 102 physically and/or logically, but still be considered external for other purposes. For example, contact center 102 may operate social media server 130 (e.g., a website operable to receive user messages from customers and/or resources 112) as one means to interact with customers via their customer communication device 104.

Customer communication devices 108 are embodied as external to contact center 102 as they are under the more direct control of their respective user or customer. However, embodiments may be provided whereby one or more customer communication devices 108 are physically and/or logically within contact center 102, such as when a customer utilizes customer communication device 108 at a kiosk, attaches to a private network of contact center 102 (e.g., WiFi connection to a kiosk, etc.) within or controlled by contact center 102, and are still considered external to contact center 102.

It should be appreciated that the description of contact center 102 provides at least one embodiment whereby the following embodiments may be more readily understood without limiting such embodiments. Contact center 102 may further be altered, added to, and/or subtracted from without departing from the scope of any embodiment described herein and without limiting the scope of the embodiments or claims, except as expressly provided.

Additionally, contact center 102 may incorporate and/or utilize social media website 130 and/or other external data sources 134 may be utilized to provide one means for a resource 112 to receive and/or retrieve contacts and connect to a customer of a contact center 102. Other external data sources 134 may include data sources, such as service bureaus or third-party data providers (e.g., credit agencies, public and/or private records, etc.). Customers may utilize their respective customer communication device 108 to send/receive communications utilizing social media website 130.

In accordance with at least some embodiments of the present disclosure, the communication network 104 may comprise any type of known communication medium or collection of communication media and may use any type of protocols to transport electronic messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center 102. Examples of a grid-based contact center 102 are more fully described in U.S. Patent Publication No. 2010/0296417 to Steiner, the entire contents of which are hereby incorporated herein by reference. Moreover, the communication network 104 may comprise a number of different communication media, such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item. Illustrative work items include, but are not limited to, a contact directed toward and received at a contact center 102, a web page request directed toward and received at a server farm (e.g., collection of servers), a media request, an application request (e.g., a request for application resources located on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media network or server 130. Exemplary architectures for harvesting social media communications and generating work items based thereon are described in U.S. patent application Ser. Nos. 12/784,369, 12/706,942, and 12/707,277, filed Mar. 20, 2010, Feb. 17, 2010, and Feb. 17, 2010, respectively, each of which is hereby incorporated herein by reference in its entirety.

The format of the work item may depend upon the capabilities of the communication device 108 and the format of the communication. In particular, work items are logical representations within a contact center 102 of work to be performed in connection with servicing a communication received at contact center 102 (and, more specifically, the work assignment mechanism 116). The communication may be received and maintained at the work assignment mechanism 116, a switch or server connected to the work assignment mechanism 116, or the like, until a resource 112 is assigned to the work item representing that communication at which point the work assignment mechanism 116 passes the work item to a routing engine 132 to connect the communication device 108, which initiated the communication, with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general, each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource 112 known to be used in contact center 102.

As discussed above, the work assignment mechanism 116 and resources 112 may be owned and operated by a common entity in a contact center 102 context. In some embodiments, the work assignment mechanism 116 may be administered by multiple enterprises, each of which has its own dedicated resources 112 connected to the work assignment mechanism 116.

In some embodiments, the work assignment mechanism 116 comprises a work assignment engine 120, which enables the work assignment mechanism 116 to make intelligent routing decisions for work items. In some embodiments, the work assignment engine 120 is configured to administer and make work assignment decisions in a queueless contact center 102, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center 102.

The work assignment engine 120 and its various components may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to contact center 102. Customer database 118 may be updated in response to a work item and/or input from resource 112 processing the work item.

In one embodiment, a message is generated by customer communication device 108 and received, via communication network 104, at work assignment mechanism 116. The message received by a contact center 102, such as at the work assignment mechanism 116, is generally, and herein, referred to as a “contact.” Routing engine 132 routes the contact to at least one of resources 112 for processing.

Content from social media server 130 may be retrieved, such as by an Application Programming Interface (API), push-notification, screen-scraper application, or other means by which content on a social media website may be accessed. Content from social media server 130 may be screened for relevance. For example, a business (e.g., the hypothetical “Alpha Airlines”) may be interested in posts explicitly directed to their company. Additionally, the business may be interested in related domains, such as operations at their airports, travel news, vendor news, customer complaints, etc. Content from social media server 130, which may be filtered to only include content having relevance to a particular business, may be captured such as in social media storage 136. As a benefit, contact center 102 may have ready access to relevant information derived from all content posted on a social media website associated with social media server 130. The relevant data on social media server 130 may be copied to populate records in social media storage 136 on an ongoing basis, upon receiving an update notification, at a previously determined interval, upon receiving a push-notification, and/or upon any other update schedule such as to balance the demand on bandwidth and data processing equipment with the need for prompt notification of new content.

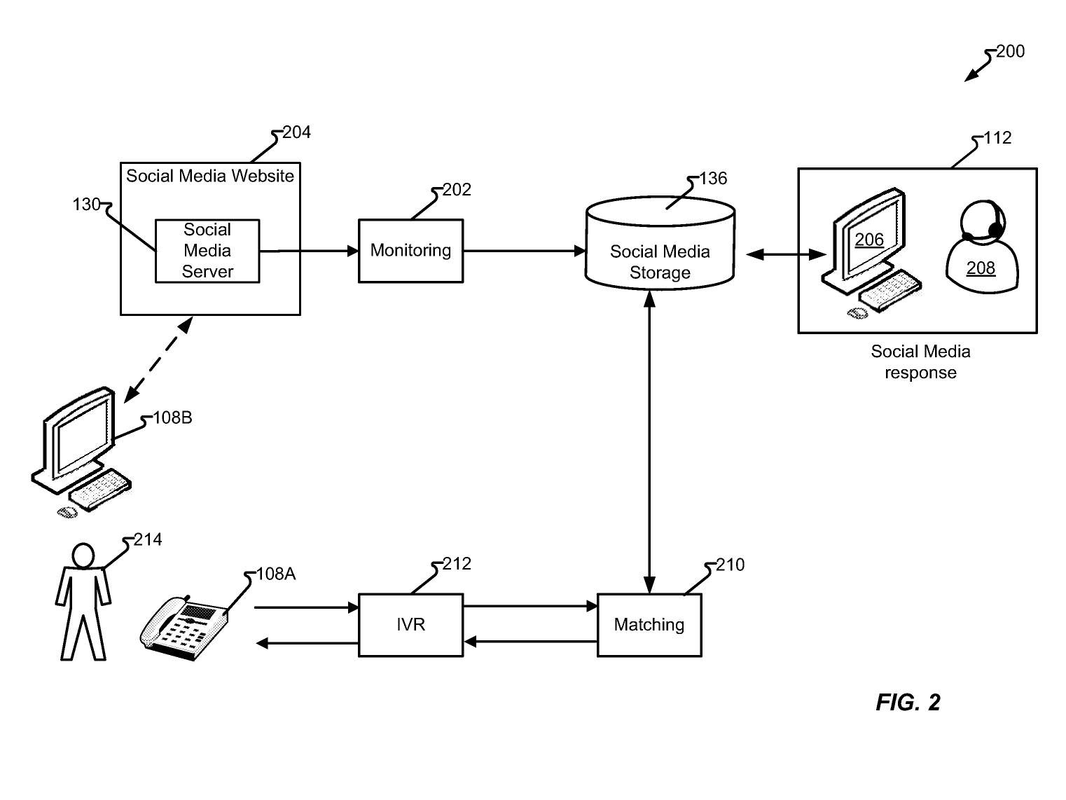

FIG. 2 depicts system 200 in accordance with embodiments of the present disclosure. In one embodiment, system 200 comprises social media server 130 providing data to monitoring module 202. Monitoring module 202 may provide an initial screening of social media server 130 content and, once a relevant post has been identified, cause social media server 130 to save the identified relevant posts. Monitoring 202 may comprise an API or other interface to access the content of social media server 130. Social media storage 136 provides ready access to relevant information that would otherwise require accessing content on social media server 130 that may otherwise be irrelevant. Social media storage 136 may comprise posts and/or indicia of posts, such as links to posts on social media server 130. In another embodiment, monitor 202 may interface with social media website 204 and obtain posts therefrom.

A particular organization may allocate or utilize resources 112 for the purpose of responding to social media posts on social media server 130. Resources 112 may access social media storage 136 and/or directly access social media server 130. However, resources 112 are finite. While underutilized automated resources 112 may be of limited consequence, human resources 112 represent a significant operational expense. A work queue may be provided for human resources 112 to enable work items to be processed with a staffing level designed to minimize underutilized resources 112, human or otherwise. Accordingly, work items in the form of posts on social media website 130, which may be accessed via social media server 130, and/or as captured by monitoring module 202 for storage in social media storage 136, may be routed to resource 112 for processing when resource 112 becomes available. For example, resource 112 may comprise human agent 208 interacting with work items via computer terminal 206. Computer terminal 206 may utilize, comprise, be comprised by, or co-located with a communications endpoint.

In another embodiment, customer 214 utilizes customer communication device 108B to post a message on social media website 204 associated with social media server 130. Monitoring module 202 identifies the post is relevant to a particular business and causes social media storage 136 to save indicia of the post or, optionally, the entirety of the post. Resource 112, once presented with the work item associated with the post, such as on terminal 206, is provided a response by agent 208. However resource 112 may not post a response, or the response may not be seen by customer 214, before customer 214 utilizes customer communication device 108A to initiate a second channel of communications to resolve the same issue presented in the post on social media server 130. While customer communication devices 108A and 108B may be physically distinct devices, it should be appreciated that a logical distinction may enable customer 214 to access two different communication channels. In another embodiment, customer communication devices 108A and 108B are the same device utilizing the same application, but, wherein customer communication device 108B is a configuration to access a social media site associated with social media server 130 and customer communication device 108A is a configuration to access a different communication channel, such as a telephony voice channel.

Interactive voice response (IVR) 212 may provide a first point of contact with customer 214. IVR 212 gathers initial information from customer 214, which may work in concert with matching module 210, in order to identify the particular issue for which customer 214 is utilizing communication device 108A. For example, IVR 212 may ask for identifying information, such as a person's name, user name, account number, etc. and/or be provided with identifying information, such as caller ID, email account, SMS ID, etc. Matching module 210 may determine with certainty or within a previously determined acceptable margin of error that an issue present in social media server 130 or represented in social media storage 136 is the same issue identified via IVR 212.

In another embodiment, matching module 210 determines customer 214 is calling about an issue already within social media storage 136. Matching module 210, or other component, may further determine that social media storage 136, social media server 130, and/or social media website 204 contain a response to the issue. Accordingly, IVR 212 may provide a notification to customer communication device 108B to inform customer 214 of the presence of a response and provide customer 214 with the opportunity to continue to wait for the next available agent or disconnect the call. IVR 212, upon prompting customer 214 for their decision, may afford customer 214 sufficient time, such as to access customer communication device 108B and social media website 204 to review the response and determine its efficacy for their particular issue. If no response exists, or if customer 214 indicates a desire to wait for the next available agent, resource 112 may then be provided with the work item associated with the issue.

In another embodiment, human agent 208 has not yet been presented with the work item. Computer terminal 206 may present the post, indicia of the post, user profile information associated with customer 214, as accessed by social media server 130, and/or other content that may be useful in relating to customer 214 and/or obtaining information for the resolution of the issue. As a further embodiment, the specific human agent 208 may be selected in accordance with content obtained from social media server 130 (e.g., the post, related post(s), past post(s), user profile, etc.) and/or information collected from IVR 212.

In another embodiment, human agent 208 is presently engaged in an exchange with customer 214, such as an audio conversation utilizing customer communication device 108A. During the engagement, monitoring module 202 and/or other component, may determine a response has been provided for the issue. Resource 112 may access the response or indicia of the response from social media storage 136 or directly, such as via an API to social media server 130. Human agent 208 may be notified of the existence of the response and/or the response itself, such as by being presented with a message on computer terminal 206 or by an automated text-to-speech message provided in a whisper mode to an audio device of human agent 208. Human agent 208 may then access, or be presented with, the response as an aid to assist customer 214 and resolve the issue associated therewith.

Matching module 210 is variously embodied. In one embodiment, matching module 210 determines that a post from social media storage 136, or optionally directly from social media server 130 and/or social media website 204, matches content from a second channel, such as determined in coordination with IVR 212, upon determining that a portion of a post matches content received by IVR 212. The portion may be a word(s), phrase(s), temporal indicators (time and/or date), location, user attribute, and/or other data including metadata, which may be determined from a post, poster (customer 214), or social media website 204.

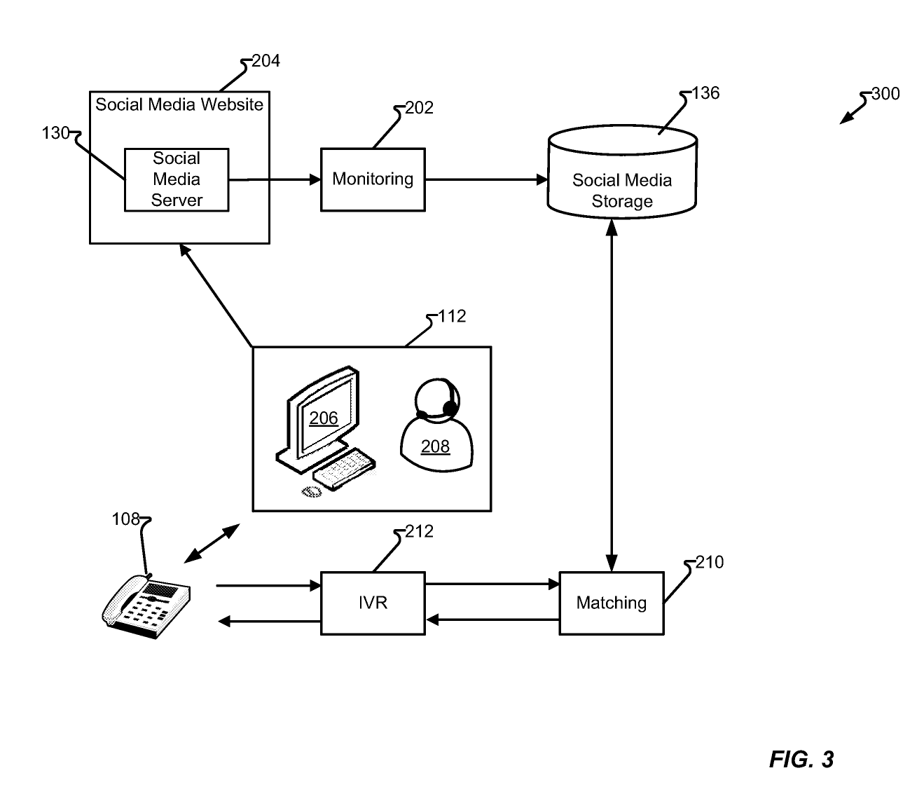

FIG. 3 depicts system 300 in accordance with embodiments of the present disclosure. In one embodiment, system 300 incorporates responses provided by human agent 208 into the social media channel. An issue presented on social media website 204 may be accessed by matching module 210 directly or via social media storage 136 populated by monitoring module 202, whereby posts on social media website 204 having a particular relevancy are captured such as to facilitate ready access thereto.

Matching module 210, such as in combination with IVR 212, may receive the same issue from customer communication device 108. If matching module 210 determines that the issue is different or that the customer associated with customer device 108 wishes to speak to a human agent, such as human agent 208, the customer may be connected to agent 208, such as by utilizing a computer terminal 206 or other communication device. Upon resource 112 determining a resolution for the issue, a response may be provided to social media website 204, which may also entail a response provided to social media server 130, concluding the issue. The response may be automatically provided, provided upon approval, such as by human agent 208 being presented with an approval menu option upon computer terminal 206 or other means, provided upon receiving edits from human agent 208, such as upon computer terminal 206, and/or upon human agent 208 receiving a prompt to provide a response via computer terminal 206 for posting on social media website 204.

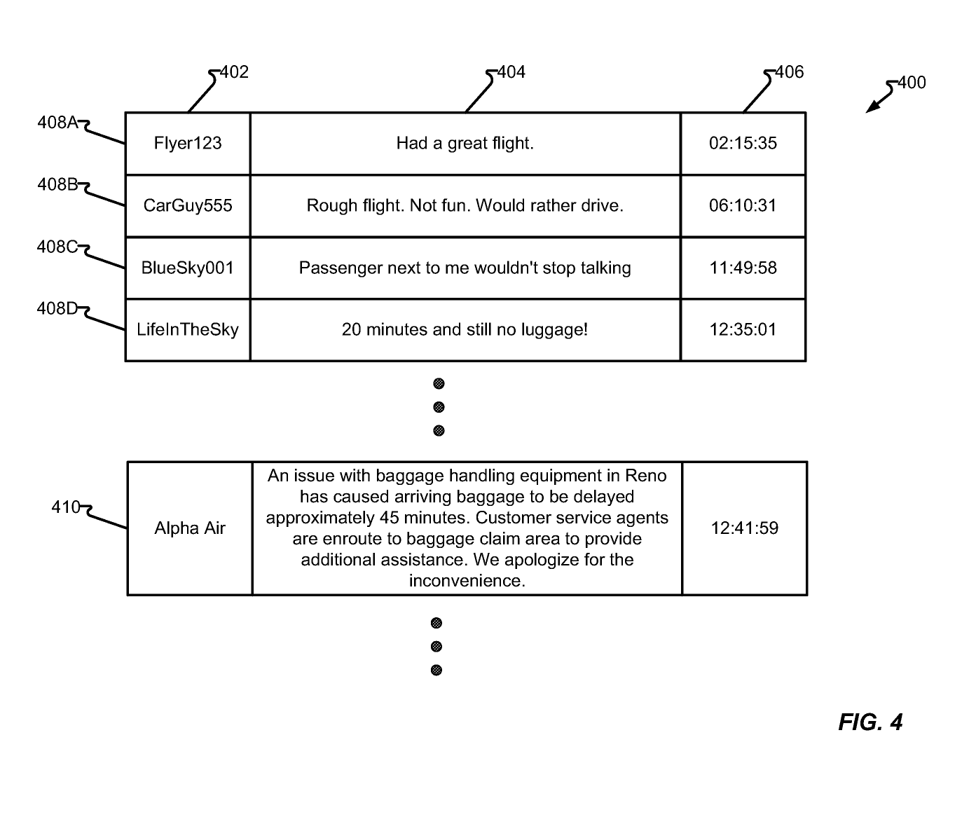

FIG. 4 depicts data structure 400 in accordance with embodiments of the present disclosure. Data structure 400 comprises a number of records 408 each having a number of data elements. In one embodiment, data structure 400 comprises a number of records 408 associated with posts and, if present, a response 410. Data structure 400 may be provided continuously or on a periodic and/or intermittent basis such as by monitoring module 202 accessing social media server 130 to populate data structure 400 residing in social media storage 136.

Records 408 may comprise social media posts, portions of social media posts, and/or other information useful to resolve an issue or identify the source of a related work item received via a different channel. For example, records 408 may comprise username data element 402, post content data element 404, time of post data element 406, and/or other data elements as may be determined as a matter of design choice.

Response 410 may similarly include data elements, such as username data element 402, post content data element 404, time of post data element 406, and/or more or fewer data elements as may be selected as a matter of design choice. Response 410 may be provided by an automated resource alone, a human resource alone, or combination thereof.

In one embodiment, monitoring module 202 accesses data structure 400 from social media server 130. Monitoring module 202 may be tuned to determine relevancy with respect to a particular domain (e.g., business, organization, industry, etc.) and select relevant posts by identifying particular post portions matching a criterion. For example, records 408A, 408B, and 408C may be determined to be non-relevant or, if relevant, not actionable (e.g., no response sought and/or no response warranted). Posts having at least a portion thereof determined to be relevant (e.g., the word “luggage” related to the domain of “Alpha Airlines”) may be selected and maintained in social media storage 136. Should a call, or other channel, receive an inquiry related to the same issue and/or the same customer, record 408D may be accessed as relevant or potentially relevant.

As discussed more fully with respect to the embodiments of FIG. 2, response 410 may be provided at various times. In one embodiment, response 410 is provided while the originating customer, or different customer similarly situated, is engaged with an automated interface to initiate a work item via a different channel (e.g., IVR 212). Similarly, the response may be an automated portion of a text chat, email, video chat, or other channel. In another embodiment, response 410 is provided during a live interaction between a customer and a human agent. In a third embodiment, response 410 is provided after a human agent has resolved the issue during a live interaction with the customer.

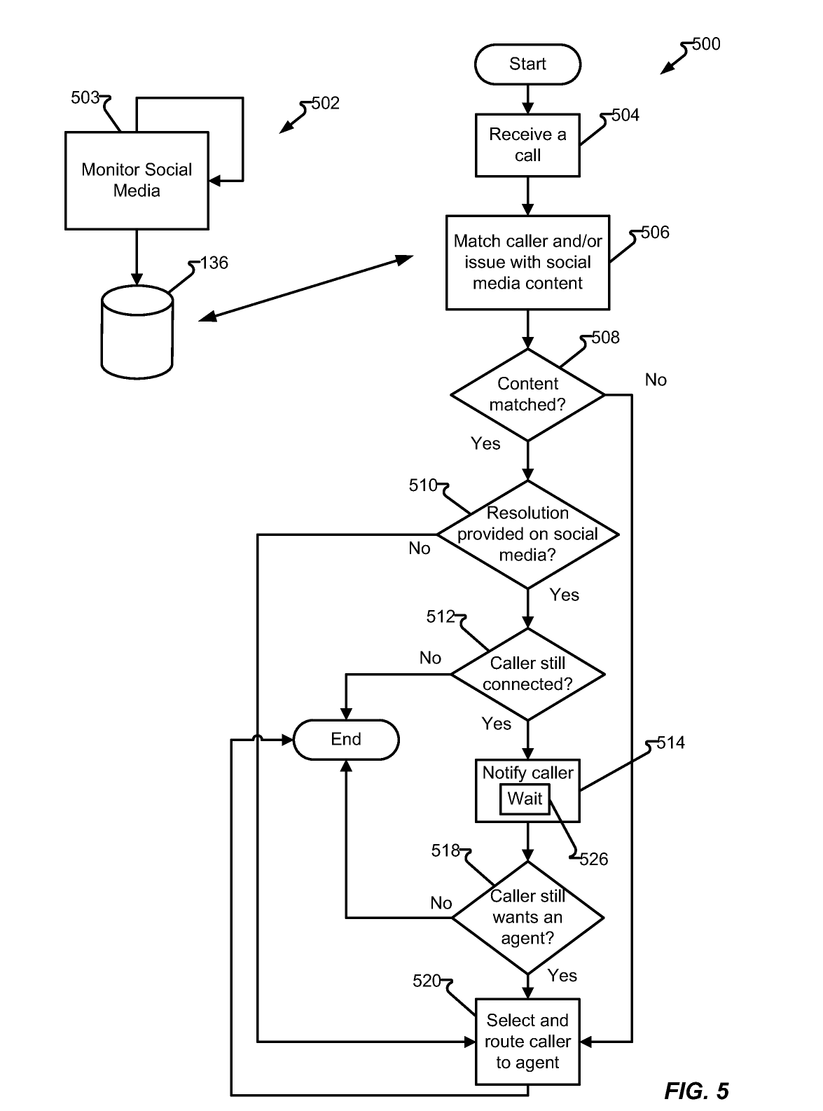

FIG. 5 depicts process 500 in accordance with embodiments of the present disclosure. In one embodiment process 500 may incorporate the output of subprocess 502. Subprocess 502 monitors social media 503, such as by monitoring module 202 accessing social media server 130, to populate social media storage 136 with relevant social media content. The relevant content may comprise a post determined to have content, or at least a portion thereof, associated with a domain of interest. Subprocess 502 may run in an uninterrupted loop, periodically, upon receiving a trigger, upon receiving a push notification, or upon any other condition or event that may facilitate accessing social media content on a timely basis without unduly burdening resources.

Step 504 receives a call initiating a work item utilizing a channel different from the social media channel associated with step 502. Step 506 matches the caller and/or an issue with content provided on a social media website, such as social media website 204. Step 508 determines if the match exists between the caller and the social media content. If step 508 is determined in the negative, process 500 may continue to step 520 wherein the caller is routed to the next available agent. If step 508 is determined in the positive, processing may continue to step 510.

Step 510 determines if a resolution is provided on social media, such as by determining the presence of a resolution record 410 within data structure 400. Alternatively, a post or posts having similar content may be identified as having a response, such as a response from a designated user (e.g., a customer service agent associated with the domain).

If step 510 is determined in the negative, process 500 may continue to step 520. However if step 510 is determined in the affirmative, and a resolution is provided on social media, step 512 may determine if the caller is still connected or otherwise still in communication. If no, process 500 may terminate. If yes, step 514 may notify the caller of the presence of the response. Delay 526 may provide the opportunity for the customer to access the social media website and the response and determine if the response is sufficient. Step 518 may prompt the customer to either disconnect or continue to hold for the next available agent. If step 518 is determined in the negative, process 500 may end. Otherwise, process 500 may continue to step 520 whereby an agent is selected and the caller is routed thereto. Optionally, step 520 may consider the social media post and/or information gathered via the secondary channel, such as during an IVR interaction, to select the specific agent to handle the call.

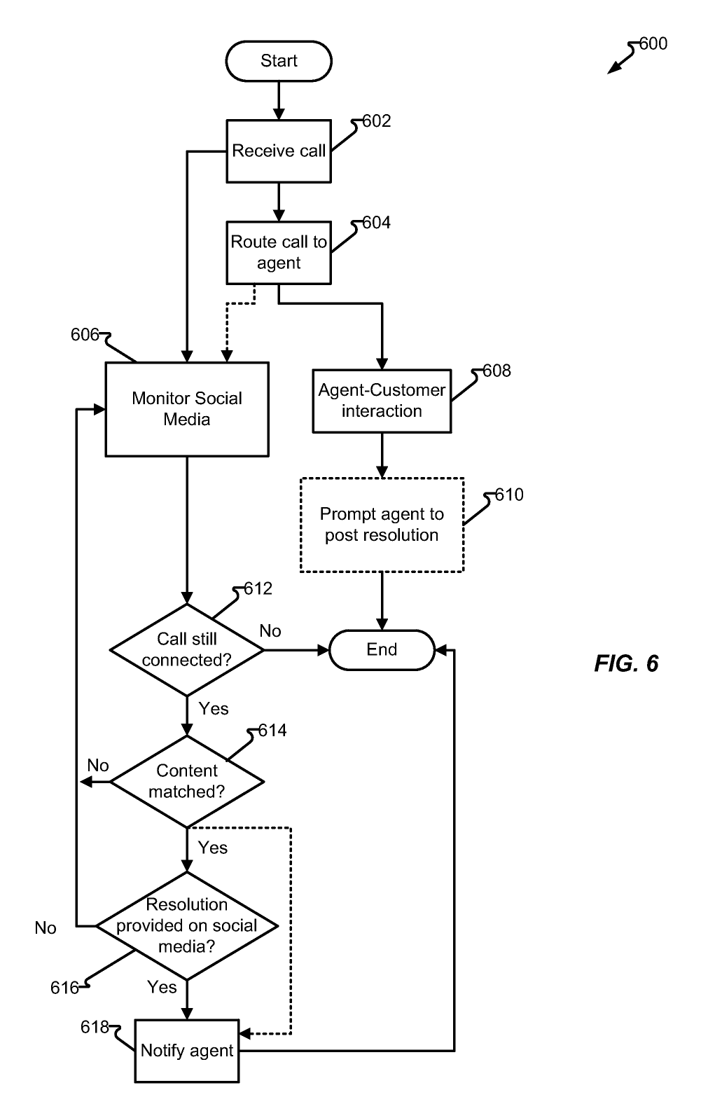

FIG. 6 depicts process 600 in accordance with embodiments of the present disclosure. Process 600 provides an embodiment, whereby an agent-customer interaction (step 608) is, or will be, conducted to address an issue posted on a social media website but with the interaction being conducted via a second channel, such as a voice channel. A response to the posted issue may come before the human agent becomes engaged or during the interaction. Accordingly, the customer and/or the agent is provided notification of the response.

In one embodiment, process 600 begins with step 602 receiving a call. Next, step 604 routes the call to an agent, such as human agent 208. Step 608 may incorporate a non-human resource 112, such as an IVR to assist in identifying the issue and/or the customer. Step 606 may follow step 602 or optionally follow step 604, whereby social media content is accessed, such as from social media storage 136 and/or directly from social media server 130, and/or social media website 204.

Step 608 provides for the interaction between the customer and the agent to resolve the issue for which they are calling. Step 608 may further incorporate an automated resource (e.g., IVR) or hold the customer in queue while waiting for an agent. Upon resolving the issue, optionally step 610 prompt the agent to post a resolution on the social media website 204 associated with the posting from the customer.

The customer may or may not still be connected via the voice channel (e.g., on hold, engaged with an IVR, talking with a human agent, etc.). If no response is provided to the posting on the social media website, steps 606, 612, 614 may loop back to step 606, whereby the monitoring of the social media website 204 continues. More specifically, step 612 monitors social media website 204 and step 612 determines if the customer is still connected. Step 612 may be determined in the negative, such as upon step 608 resolving the issue or the customer abandoning the call. However, if step 612 determines the customer is still engaged, processing may continue to step 614 and determine whether the content associated with the call matches content from a social media website 204 monitored in step 606. If step 614 is determined in the negative (no matching content has been provided), process 600 may loop back to step 606 to continue monitoring the social media website 204.

If step 614 is determined in the affirmative, process 600 may continue to step 616, whereby a determination is made whether a sufficient resolution has been provided. Step 616 may be determined by the customer, such as by allowing the customer to access the response and receive the customer's queue to conclude the call or not. If step 616 is determined in the negative, processing may continue back to step 606, during which time agent-customer interaction step 608 may be enqueued or underway. Optionally, step 614, upon determining that the content matches, may notify the agent in step 618 of the response to supplement agent-customer interaction step 608. Next, step 616 determines if the resolution provided in the response is sufficient. If step 616 is determined in the affirmative, the agent may be notified in step 618. If the agent resolves the issue in step 608, without step 616 being answered in the affirmative, the resolution may be automatically provided as a response to the social media website 204. Optionally, step 610 may prompt the agent to post the resolution, approve an automatically generated resolution, and/or edit an automatically generated resolution to place in proper form and post the resolution to the social media website 204.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU), or logic circuits programmed with the instructions to perform the methods (FPGA). These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including but not limited to wireless, wireline, optical fiber cable, RF, etc., or any suitable combination of the foregoing.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A system, comprising:
a network interface that accesses content from a social media website and receives a communication via a communications network different from the social media website; and
a processor that, upon determining that the communication from the communications network is associated with content from the social media website, causes the communications network to present a notification to a contact center person associated therewith, the notification comprising indicia of the associated content from the social media website.

2. The system of claim 1, further comprising:
a database that maintains the accessed content from the social media website;
wherein the processor accesses the social media website and, upon determining a portion of the social media website is relevant to a domain, causes the database to store the portion of the social media website; and
wherein the processor determines that the communication from the communications network is associated with content from the social media website by determining that the communication is associated with at least a subportion of the stored portion of the social media website.

3. The system of claim 1, wherein the processor determines that the communication from the communications network is associated with content from the social media website by prompting the customer to provide indicia of the content on the social media website and determining the degree of match between the indicia and the content from the social media website, and upon determining the degree of match is greater than a previously determined threshold, assigning the communication as associated with the content from the social media website.

4. The system of claim 3, wherein the indicia of the communication is an identity of the customer associated with content from the social media website.

5. The system of claim 3, wherein the indicia of the communication is an identity of the subject of the content from the social media website.

6. The system of claim 3, wherein the indicia of the communication is an identity of a temporal identifier associated with content from the social media website.

7. The system of claim 1, wherein the processor monitors the content from the social media website for a response to the content from the social media website.

8. The system of claim 7, wherein the processor, upon determining that the response exists, notifies the customer of the existence of the response via the communications network of the response.

9. The system of claim 7, wherein the processor, upon determining that the response exists, notifies an agent engaged in the communication with the customer to be notified of the existence of the response.

10. The system of claim 7, wherein the processor, upon determining that the response does not exist, determines that the agent has provided the customer with a resolution, provides indicia of the resolution to the social media website as the response.

11. The system of claim 7, wherein the processor, upon determining that the response does not exist, determines that the agent has provided the customer with a resolution and prompts the agent to provide indicia of the resolution to the social media website as the response.

12. A means for determining association between a customer communicating on a communications network and content on a social media website, comprising:
accessing means configured to access content from a social media website and receive a communication via the communications network different from the social media website; and
determining means configured to determine that the communication from the communications network is associated with content from the social media website and cause a presentation means to present a notification to at least one of a contact center person engaged in the communication, the notification comprising indicia of the associated content from the social media website.

13. The means of claim 12, wherein:
a data storage means configured to maintain the accessed content from the social media website;
the processing means further comprises means to access the social media website and, upon determining a portion of the social media website is relevant to a domain, causes the database to store the portion of the social media website; and
the processing means further comprises means to determine that the communication from the communications network is associated with content from the social media website by determining that at least a subportion of the stored portion of the social media website is maintained by the data storage means and is associated with content from the social media website.

14. The means of claim 12, wherein the processing means is further configured to determine that the communication from the communications network is associated with content from the social media website by causing prompting means to prompt the customer to provide indicia of the communication and determining the degree of match between the indicia and the content from the social media website and, upon determining the degree of match is greater than a previously determined threshold, assigning the communication as associated with the content from the social media website.

15. The means of 12, wherein the processing means is further configured to monitor the content from the social media website for a response to the content from the social media website and, upon determining that the response exists, causes a notification means to notify the customer of the existence of the response via the communications network of the response.

16. A method, comprising:
accessing content from a social media website;
receiving a communication via a communications network different from the social media website; and
upon determining that the communication from the communications network is associated with content from the social media website, presenting a notification to at least one of a contact center person engaged in the communication, the notification comprising indicia of the associated content from the social media website.

17. The method of claim 16, further comprising:
storing at least a portion of the accessed content from the social media website;
wherein the step of accessing further comprises accessing the at least stored portion; and
wherein the step of determining further comprises determining that the communication from the communications network is associated with at least a subportion of the stored portion.

18. The method of claim 16, wherein, the step determining, further comprises prompting the customer to provide indicia of the content on the social media website and determining the degree of match between the indicia and the content from the social media website, and, upon determining the degree of match is greater than a previously determined threshold, assigning the communication as associated with the content from the social media website.

19. The method of claim 16, further comprising, monitoring the social media website for a response to the content from the social media website.

20. The method of claim 19, further comprising:
upon determining that the response exists, notifying the contact center person engaged in the communication with the customer of the response.
